(19) United States
(12) Patent Application Publication
(10) Pub. No.: US 2011/0055380 A1
(43) Pub. Date: Mar. 3, 2011

(54) NETWORK PROVIDING AUTOMATIC CONNECTIONS BETWEEN DEVICES BASED ON USER TASK

(76) Inventors: Robert F. Yockey, Fort Collins, CO (US); David H. Hanes, Loveland, CO (US); John Michael Main, Fort Collins, CO (US)

(21) Appl. No.: 12/553,215

(22) Filed: Sep. 3, 2009

(51) Int. Cl. G06F 15/173; G06F 15/16

(52) U.S. Cl. 709/224; 709/227; 709/223; 709/226

(57) ABSTRACT

A system including a network; and a plurality of devices configured to be communicatively coupled to the network, each device configured to be automatically discoverable when connected to the network; wherein at least one of the devices is configured to: discover devices connected to the network; and establish a network communication link between at least two devices based on a user task.

### BACKGROUND

Peripheral devices, such as keyboards, mice, monitors, speakers, cameras, etc., used with computing devices, such as personal computers (PCs), servers, etc., are typically permanently associated with a single computing device and directly connected to that computing device. Typical connections between a peripheral device and a computing device are universal serial bus (USB) and PS2. Each computing device typically either uses its own set of peripheral devices or shares a set of peripheral devices with other computing devices through a keyboard, video, and mouse (KVM) switch that is directly wired to all the devices. Remote control software may also be installed on a PC for controlling the PC via a remote device. Remote control software, however, does not allow BIOS level interactions with the PC. In addition, remote control software does not work well with non-PC devices, such as embedded devices.

For these and other reasons, a need exists for the present invention.

### BRIEF DESCRIPTION OF THE DRAWINGS

FIG. 1 is a diagram illustrating one embodiment of a network system.

FIG. 2 is a diagram illustrating one embodiment of a system providing automatic connections based on a user task.

FIG. 3 is a flow diagram illustrating one embodiment of a method for discovering devices on a network.

FIG. 4 is a flow diagram illustrating one embodiment of an operation of the system.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

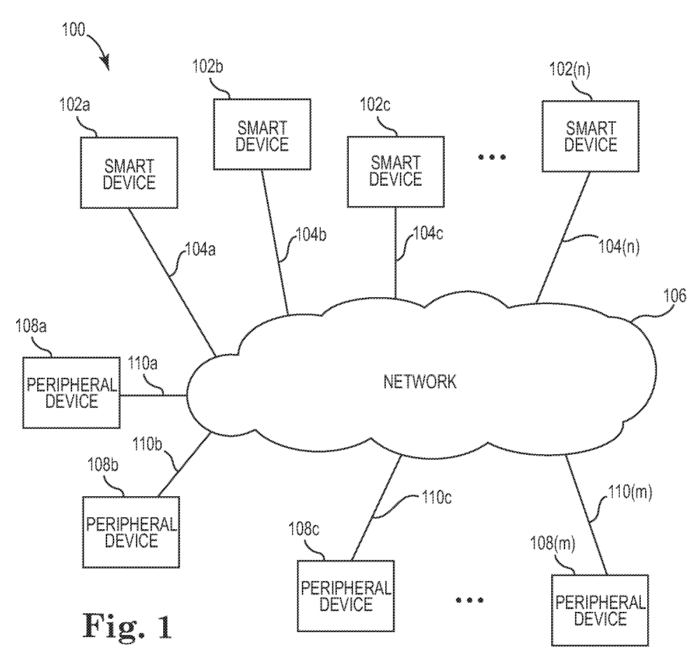

FIG. 1 is a diagram illustrating one embodiment of a network system 100. Network system 100 includes a plurality of smart devices 102a-102(n), a plurality of peripheral devices 108a-108(m), and a network 106, where “n” and “m” indicate any suitable number of smart devices and peripheral devices, respectively. Each smart device 102a-102(n) is communicatively coupled to network 106 through a communication link 104a-104(n), respectively. Each peripheral device 108a-108(m) is communicatively coupled to network 106 though a communication link 110a-110(m), respectively. In one embodiment, each smart device 102a-102(n) and each peripheral device 108a-108(m) includes a unique address or identifier (ID) for communicating with other devices over network 106 using a network protocol. The network protocol includes internet protocol (IP), transmission control protocol (TCP), user datagram protocol (UDP), or other suitable network protocol.

Each smart device 102a-102(n) includes a transform/computing device such as a personal computer (PC), a server, a cell phone, a smart phone, a personal video recorder (PVR), a digital video recorder (DVR), or other suitable transform/computing device. Each peripheral device 108a-108(m) includes an input/output (I/O) device such as a keyboard, a mouse, a remote control, a game controller, a microphone, a webcam, a digital camera, a camcorder, a scanner, a PVR/DVR, a cell phone, a touch display, a speaker, a television, a display, a printer, an all-in-one printer, a headset, an audio component, a digital picture frame, or other suitable I/O device. Network 106 includes any suitable number of interconnected switches, hubs, bridges, repeaters, routers, and/or other suitable network devices for passing communications between one or more smart devices 102a-102(n) and one or more peripheral devices 108a-108(m). Network 106 includes a wired Ethernet network, a wireless Ethernet network, an 802.11 network, a Bluetooth network, a combination thereof, or another suitable network.

In one embodiment, network system 100 provides an architecture of internet protocol (IP) network attached smart devices 102a-102(n) and peripheral devices 108a-108(m). The architecture provides methods for automatic discovery of smart devices 102a-102(n) and peripheral devices 108a-108(m), for dynamic binding of peripheral devices 108a-108(m) into groups, and for switching of groups of peripheral devices 108a-108(m) between networked smart devices 102a-102(n). For each group of peripheral devices, group properties are set including bandwidth prioritization properties. Based on the bandwidth prioritization properties, network bandwidth is allocated to assure timely IP communications between devices. The architecture enables any set of IP enabled peripheral devices to be associated with any smart device on the network for I/O functions associated with those devices.

Any smart device 102a-102(n) can use any set or group of peripheral devices 108a-108(m) attached to network 106. Any group of peripheral devices 108a-108(m) can control any smart device 102a-102(n) attached to network 106. Therefore, a many to many device topology is provided. In one embodiment, a level of service to peripheral devices is guaranteed depending upon the critical or real time nature of the peripheral devices. In this embodiment, network system 100 can gracefully degrade lower priority devices for higher priority devices.

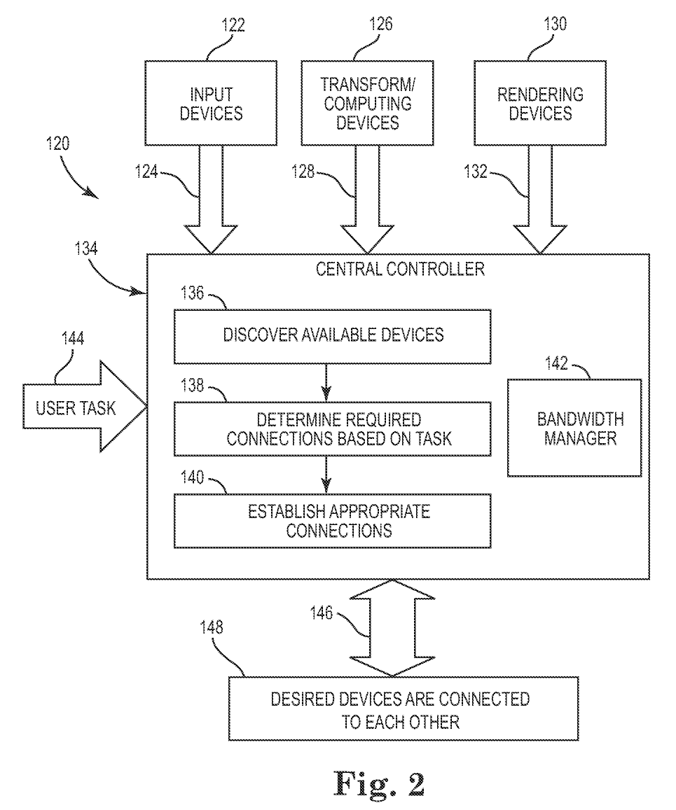

FIG. 2 is a diagram illustrating one embodiment of a system 120 providing automatic connections based on a user task. System 120 includes input devices 122, transform/computing devices 126, rendering devices 130, and a central controller 134. Input devices 122 are communicatively coupled to central controller 134 through communication links 124. Transform/computing devices 126 are communicatively coupled to central controller 134 through communication links 128. Rendering devices 130 are communicatively coupled to central controller 134 through communication links 132. In one embodiment, communication links 124,128, and 132 are network communication links.

In one embodiment, input devices 122 and rendering devices 130 are peripheral devices as previously described and illustrated with reference to FIG. 1. Input devices 122 include keyboards, mice, remote controls, game controllers, microphones, webcams, digital cameras, camcorders, scanners, PVR/DVRs, cell phones, touch displays, or other suitable input devices. Rendering devices 130 include speakers, televisions, displays, printers, all-in-one printers, headsets, audio components, cell phones, digital picture frames, touch displays, or other suitable rendering devices. In one embodiment, transform/computing devices 126 are smart devices as previously described and illustrated with reference to FIG. 1. Smart devices 126 include PCs, servers, cell phones, smart phones, PVR/DVRs, or other suitable transform/computing devices.

Each of the input devices 122, transform/computing devices 126, and rendering devices 130 includes hardware capable of connecting to a network, such as a wireless network interface or another suitable network interface. Each of the transform/computing devices 126 includes device drivers for interfacing with input devices 122 and rendering devices 130.

In one embodiment, central controller 134 is one of an input device 122, a transform/computing device 126, and a rendering device 130. In one embodiment, one of an input device 122, a transform/computing device 126, and a rendering device 130 is statically assigned to provide central controller 134. In another embodiment, one of an input device 122, a transform/computing device 126, and a rendering device 130 is dynamically assigned to provide central controller 134. The dynamic assignment of one of an input device 122, a transform/computing device 126, and a rendering device 130 as central controller 134 can be based on device properties, a user task, or other suitable criteria.

Central controller 134 receives a user task input 144. User task input 144 can be any user task, such as searching for a television show on a DVR, opening a document on a PC, watching a DVD, etc. Central controller 134 receives the user task input directly or through one of input devices 122, transform/computing devices 126, and rendering devices 130. Central controller 134 performs a process indicated by blocks 136, 138, and 140 and manages bandwidth within the network as indicated at 142.

At 136, central controller 134 discovers available devices, including input devices 122, transform/computing devices 126, and rendering devices 130. At 138, central controller 134 determines the required connections between available input devices 122, transform/computing devices 126, and rendering devices 130 based on user task 144. At 140, central controller 134 establishes the appropriate connections between available input devices 122, transform/computing devices 126, and rendering devices 130 for performing user task 144. Central controller 134 establishes the appropriate connections through communications links 146 such that the desired devices are connected to each other as indicated at 148. In one embodiment, once the user task is completed, central controller 134 disconnects the devices that are connected to each other.

In another embodiment, each of the input devices 122, transform/computing devices 126, and rendering devices 130 is capable of discovering the other input devices 122, transform/computing devices 126, and rendering devices 130 connected to the network. In one embodiment, the discovery process allows a device to enumerate a list of available devices along with I/O capabilities and settings. The discovery process can be limited to a local area network or expanded to a wide area network. In one embodiment, devices are discovered by using a network broadcast or a network multicast mechanism. The discovery process can be performed using an industry standard protocol such as Simple Service Discovery Protocol (SSDP) or another suitable protocol.

In one embodiment, any one of the input devices 122, transform/computing devices 126, and rendering devices 130 connected to the network can initiate a discovery process to find other devices connected to the network. In one embodiment, one of the input devices 122, transform/computing devices 126, and rendering devices 130 connected to the network acts as a hub or center of discovery (i.e., central controller 134) as indicated at 136. In one embodiment, central controller 134 is elected to be the hub from among the input devices 122, transform/computing devices 126, and rendering devices 130. This protocol enables devices to be connected and disconnected from the network while the remaining devices perform a reelection to determine a new central controller 134.

In one embodiment, a user can dynamically bind and unbind input devices 122 and rendering devices 130 into groups of I/O peripherals. For example, a keyboard, a mouse, a display, and a printer in a home office could be bound to a PC, or a remote control in a living room could be bound to a television. In one embodiment, the binding and unbinding is performed by a software application executed by central controller 134 as indicated at 138 and 140. In another embodiment, the binding and unbinding is performed by each device itself using physical proximity, touch, coding, or other suitable mechanism.

The grouped I/O peripherals are switched to various transform/computing devices 126. For example, a button on a remote control, keyboard, or mouse could be used to round robin toggle to different transform/computing devices 126. In one embodiment, central controller 134 executes a software-based switch board application for switching grouped I/O peripherals between various transform/computing devices 126. In another embodiment, the switching could be performed by a device that includes user input capabilities, such as a remote control with a screen and keys.

Bandwidth manager 142 of central controller 134 manages and allocates network bandwidth to and within grouped I/O peripherals. In one embodiment, the properties of each I/O device within a group are set. The properties include basic properties for each device individually and bandwidth prioritization properties for each device within a group. The bandwidth prioritization properties are based on some devices generating more data than other devices and some devices having time-sensitive data that takes priority over the data generated by other devices.

For example, in one embodiment, five different priority levels are defined, with the first priority level being the most critical and the fifth priority level being the least critical. The first priority level is defined as critical (e.g., voice over internet protocol (VOIP) for emergency calls, home security monitoring and alarms). The second priority level is defined as real time critical (e.g., standard VOIP, streaming audio/video, gaming controls, standard displays). The third priority level is defined as real time user interaction (e.g., standard keyboard and mouse, user interface (UI) display). The fourth priority level is defined as background critical (e.g., synchronization). The fifth priority level is defined as background non-critical (e.g., image transfer, printing). In other embodiments, another suitable number of priority levels are defined.

With the bandwidth prioritization properties set for each device, central controller 134 allocates bandwidth among all grouped I/O peripherals and bound transform/computing devices 126 to guarantee a certain assurance of bandwidth to the most critical applications. In one embodiment, a user interface is provided to display on any suitable display a network traffic summary, network allocations, bandwidth bottlenecks, or any other suitable information regarding network status.

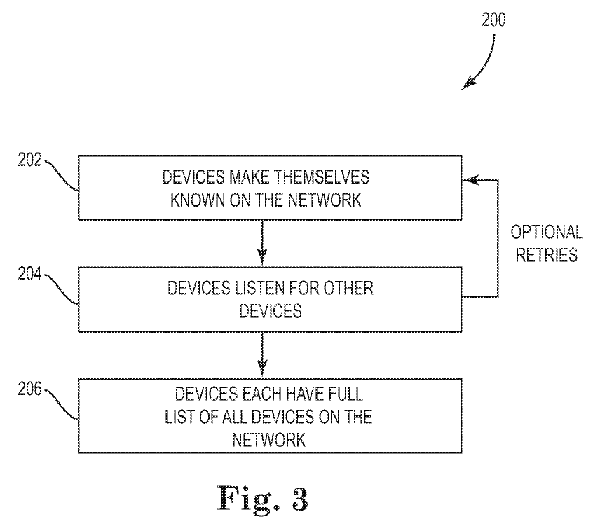

FIG. 3 is a flow diagram illustrating one embodiment of a method 200 for discovering devices on a network. At 202, smart devices and peripheral devices make themselves known on the network once they are communicatively coupled to the network. The devices make themselves known on the network by broadcasting their presence or by using another suitable technique. At 204, each smart device and peripheral device on the network listens for other devices on the network. In one embodiment, each device periodically returns to block 202 where the device again makes itself known on the network. At 206, each device has a full list of all other devices connected to the network. Based on the properties for each device, connections between the devices can now be formed based on a user task.

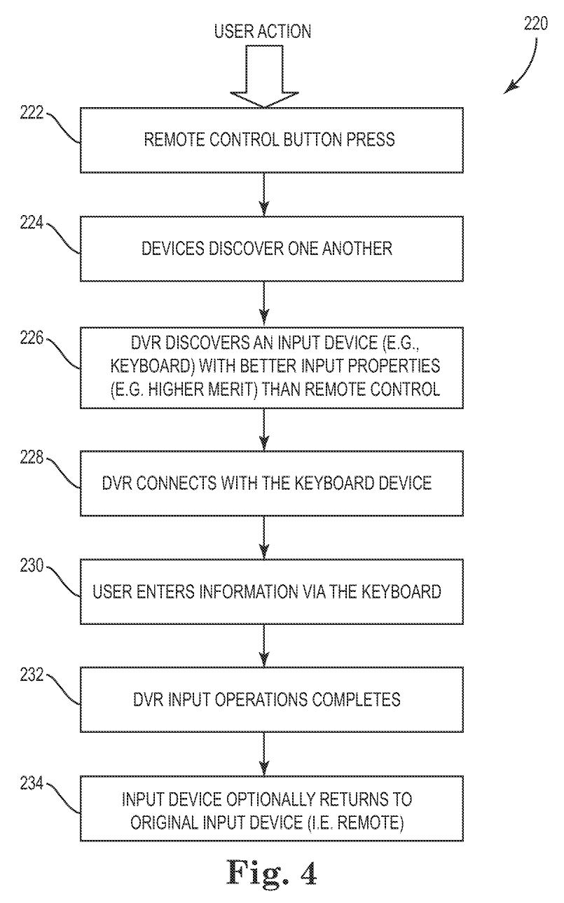

FIG. 4 is a flow diagram illustrating one embodiment of an operation 220 of the system. Operation 220 describes an operation where a user enters information into a DVR for searching for a show by name or for performing another similar task. At 222, a user performs an action to initiate the operation. In this example, the action is a button press on a remote control. At 224, in response to the button press on the remote control, devices connected to the network discover one another. At 226, the DVR discovers an input device (e.g. a keyboard) with better input properties (e.g., higher merit) than the remote control. At 228, the DVR connects with the keyboard device over the network. In one embodiment, the user is informed via an on-screen display that the DVR has connected to the keyboard device. At 230, the user enters information for performing the task via the keyboard. At 232, the DVR input operation completes. At 234, the input device (i.e., the keyboard) optionally returns to the original input device (i.e., the remote control).

Operation 220 is just one example for using network system 100. One skilled in the art will recognize that a wide variety of different operations using different smart devices and peripheral devices are possible. Each operation is based on the desired user task and the available devices for completing the task.

Embodiments of the present invention provide a network including peripheral devices that are automatically discovered, dynamically grouped, and switched between smart devices on the network. Embodiments provide for setting group properties including bandwidth prioritization properties for allocating network bandwidth to assure timely communications. Embodiments enable any suitable peripheral device on the network to be associated with any suitable smart device on the network for I/O functions associated with those smart devices.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
a network; and
a plurality of devices configured to be communicatively coupled to the network, each device configured to be automatically discoverable when connected to the network;
wherein at least one of the devices is configured to:
discover devices connected to the network; and
establish a network communication link between at least two devices based on a user task.

2. The system of claim 1, wherein the devices comprise at least one smart device and at least one peripheral device.

3. The system of claim 1, wherein the network comprises an internet protocol network.

4. The system of claim 1, wherein at least one of the devices is configured to allocate network bandwidth to the devices connected to the network.

5. A system comprising:
a network;
a plurality of peripheral devices configured to be connected to the network;
a plurality of smart devices configured to be connected to the network;
wherein one of the peripheral devices or smart devices acts as a central controller, the central controller configured to:
receive an input indicating a user task;
discover available peripheral devices and smart devices connected to the network;
identify which of the available peripheral devices and smart devices are required to complete the user task; and
establish network communication links between the identified peripheral devices and smart devices to complete the user task.

6. The system of claim 5, wherein the central controller is configured to allocate bandwidth to the network communication links based on priority settings of the peripheral devices and smart devices.

7. The system of claim 5, wherein the central controller is configured to disconnect the network communication links between the identified peripheral devices and smart devices in response to the user task being completed.

8. The system of claim 5, wherein the peripheral devices comprise at least one of a keyboard, a mouse, a remote control, a game controller, a microphone, a webcam, a digital camera, a camcorder, a scanner, a personal video recorder (PVR), a digital video recorder (DVR), a cellular phone, a touch display, a speaker, a display, a printer, a headset, an audio system, and a digital picture frame.

9. The system of claim 5, wherein the smart devices comprise at least one of a personal computer (PC), a server, a cellular phone, a smart phone, a personal video recorder (PVR), and a digital video recorder (DVR).

10. The system of claim 5, wherein the network comprises an internet protocol (IP) network.

11. A method for completing a user task via devices communicatively coupled to a network, the method comprising:
discovering, via at least one of the devices, devices that have been communicatively coupled to the network;
detecting, via at least one of the devices, a user task;
identifying, via at least one of the devices, which of the discovered devices are needed for completing the user task; and
establishing communication links between the identified devices to complete the user task.

12. The method of claim 11, further comprising:
communicatively coupling an additional device to the network; and
broadcasting, via the additional device, the presence of the additional device on the network.

13. The method of claim 11, wherein discovering devices comprises discovering at least one smart device and at least one peripheral device.

14. The method of claim 11, further comprising:
disconnecting the communication links between the identified devices once the user task is completed.

15. The method of claim 11, further comprising:
allocating network bandwidth, via at least one of the devices, to the established communication links based on a priority setting for each of the identified devices.
